(19) United States
(12) Patent Application Publication
(10) Pub. No.: US 2026/0220443 A1
(43) Pub. Date: Jul. 30, 2026

(54) System, Method, and Computer Program Product for Secure Inference in Multi-Party Computation

(71) Applicant: Visa International Service Association, San Francisco, CA (US)

(72) Inventors: Mazharul Islam, Fremont, CA (US); Sunpreet Singh Arora, San Jose, CA (US); Peter Byerly Rindal, San Francisco, CA (US); Maliheh Shirvanian, Santa Clara, CA (US)

(21) Appl. No.: 19/147,405

(22) PCT Filed: Jan. 17, 2024
(86) PCT No.: PCT/US24/11820

§ 371 Date: Jul. 11, 2025

Related U.S. Application Data
(60) Provisional application No. 63/439,311, filed on Jan. 17, 2023.
(60) Provisional application No. 63/535,588, filed on Aug. 31, 2023.

(51) Int. Cl. G06N 3/048; H04L 9/08

(52) U.S. Cl. CPC G06N 3/048; H04L 9/085; H04L 2209/46

(57) ABSTRACT

Systems, methods, and computer program products are provided for secure inference in a multi-party computation (MPC) setting. The system may include at least one processor configured to receive data associated with a machine learning model, generate an approximation of a complex activation function of the machine learning model, generate an updated machine learning model based on the approximation of the complex activation function, and provide the updated machine learning model to a plurality of MPC nodes, wherein the plurality of MPC nodes perform an inference task using the updated machine learning model as part of an MPC protocol.

### CROSS-REFERENCE TO RELATED APPLICATIONS

This application is the national phase of International Application No. PCT/US24/11820, filed on Jan. 17, 2024, and claims priority to U.S. Provisional Patent Application No. 63/439,311, filed on Jan. 17, 2023, and U.S. Provisional Patent Application No. 63/535,588, filed on Aug. 31, 2023, the disclosures of which are hereby incorporated by reference in their entireties.

### BACKGROUND

### 1. Technical Field

This disclosure relates generally to secure inference procedures and, in non-limiting embodiments or aspects, to systems, methods, and computer program products for providing secure inference in a multi-party computation setting.

### 2. Technical Considerations

Machine learning may refer to a field of computer science that uses techniques that automate analytical model building to provide a computer system with the ability to learn (e.g., progressively improve performance of) a task with a given dataset. In some instances, a machine learning model may be created for a specific dataset so that the machine learning model may perform a task (e.g., a biometric authentication task) with regard to the dataset. In the context of machine learning, inference may refer to the use of a machine learning model to make predictions and/or decisions based on new data that was not previously provided to the machine learning model (e.g., during training).

Multi-party computation (e.g., MPC, secure computation, secure multi-party computation, privacy-preserving computation, etc.) may refer to a cryptographic protocol that allows multiple entities to jointly compute a function over inputs while keeping the inputs secure (e.g., private). MPC may be used by one or more entities to perform computations, such as secure inference, on encrypted data securely. Secure inference refers to the process of performing an inference task by a machine learning model in a secure and privacy-preserving manner. In some instances, secure inference may include performing an inference task in a setting with an MPC protocol. In the context of secure inference, the MPC protocol may be applied to protect the machine learning model and/or the input data that is to be provided to the machine learning model for the inference task.

However, some machine learning models may be ineffective at performing inference tasks in a secure setting that uses an MPC protocol. For instance, a machine learning model that includes a complex activation function, such as activation function that is highly non-linear, may not be compatible with the MPC protocol. In such instances, the MPC protocol may be optimized for evaluating a linear activation function, but the MPC protocol may not be capable of evaluating non-linear functions in this way. This may result in inaccurate outputs of the machine learning model and/or the consumption of excessive network and computational resources when performing inference tasks.

### SUMMARY

Accordingly, provided are improved systems, methods, and computer program products for providing secure inference in a multi-party computation (MPC) setting.

According to non-limiting embodiments or aspects, provided is a system including at least one processor that is configured to receive data associated with a machine learning model, generate an approximation of a complex activation function of the machine learning model, generate an updated machine learning model based on the approximation of the complex activation function, and provide the updated machine learning model to a plurality of multi-party computation (MPC) nodes, wherein the plurality of MPC nodes perform an inference task using the updated machine learning model as part of an MPC protocol.

According to non-limiting embodiments or aspects, provided is a method, including receiving, with at least one processor, data associated with a machine learning model, generating, with at least one processor, an approximation of a complex activation function of the machine learning model, generating, with at least one processor, an updated machine learning model based on the approximation of the complex activation function, and providing, with at least one processor, the updated machine learning model to a plurality of multi-party computation (MPC) nodes, wherein the plurality of MPC nodes perform an inference task using the updated machine learning model as part of an MPC protocol.

According to non-limiting embodiments or aspects, provided is a computer program product including a non-transitory computer readable medium comprising one or more instructions that, when executed by at least one processor, cause the at least one processor to receive data associated with a machine learning model, generate an approximation of a complex activation function of the machine learning model, generate an updated machine learning model based on the approximation of the complex activation function, and provide the updated machine learning model to a plurality of multi-party computation (MPC) nodes, wherein the plurality of MPC nodes perform an inference task using the updated machine learning model as part of an MPC protocol.

Further non-limiting embodiments or aspects are set forth in the following numbered clauses:
Clause 1: A system comprising at least one processor, wherein the at least one processor is configured to: receive data associated with a machine learning model; generate an approximation of a complex activation function of the machine learning model; generate an updated machine learning model based on the approximation of the complex activation function; provide the updated machine learning model to a plurality of multi-party computation (MPC) nodes, wherein the plurality of MPC nodes perform an inference task using the updated machine learning model as part of an MPC protocol.
Clause 2: The system of clause 1, wherein the at least one processor is further configured to: provide a result of the inference task using the MPC protocol.
Clause 3: The system of clause 1 or 2, wherein, when generating the approximation of the complex activation function of the machine learning model, the at least one processor is further configured to: determine a first output of the machine learning model using a first activation function; calculate an approximate error term using an error polynomial based on the first output of the machine learning model, wherein the error polynomial comprises a plurality of spline-based terms; generate an approximation of an output of the machine learning model using a second activation function based on the first output of the machine learning model and the approximate error term; and wherein the first activation function comprises the complex activation function and the second activation function comprises the approximation of a complex activation function of the machine learning model.
Clause 4: The system of any of clauses 1-3, wherein the plurality of spline-based terms comprises a plurality of unevenly spaced 1 dimensional splines.
Clause 5: The system of any of clauses 1-4, wherein, when calculating the approximate error term, the at least one processor is configured to: sum the plurality of spline-based terms.
Clause 6: The system of any of clauses 1-5, wherein the at least one processor is further configured to: cause an inference task to be performed by the plurality of MPC nodes using the updated machine learning model as part of an MPC protocol.
Clause 7: The system of any of clauses 1-6, wherein the at least one processor is further configured to: generate the error polynomial based on the formula:

$$δ ← \frac{{\int }_{s}^{e} P ( x ) * Error ( x , {\hat{F}}_{crude} )}{N}$$

$$c ← s :$$

$$SP ← ∅$$

$$while c < e$$

$${δ}_{crude} ← Error ( P ( x ) , s , c , {\hat{F}}_{crude} )$$

$$if {δ}_{crude} > δ :$$

$${f}_{[ c , e ]} ( x ) ← INTERPOLATE ( [ c , e ] , F , \hat{F} , D )$$

$$SP ← S ( {f}_{[ c . e ]} ( x ) , s , c )$$

$$s ← c$$

$$c ← c + Δ$$

$$return SP$$

wherein: F(x) is a complex activation function; \hat{F}_{crude} is an approximation of F(x); s is a starting point for approximation F(x); e is an ending point for approximation F(x); N is a number of piece-wise polynomials used for approximation; D is a maximum degree of each of N; i is a starting point of a domain of a plurality of domains; j is an ending point of a domain of the plurality of domains; ƒ_{[i,j]}(x) is a polynomial to interpolate the approximate error term between [i,j]; S(ƒ(x) i,j) is a polynomial piece S between point [i,j] with polynomial ƒ(x) of degree at most D; P(x) is a probability distribution of x; Δ is a step size; δ is an approximation error; c is a pointer starting at s, wherein c moves forward by the step size, Δ; and SP is an approximation of the error of \hat{F}_{crude}.
Clause 8: A method, comprising: receiving, with at least one processor, data associated with a machine learning model; generating, with at least one processor, an approximation of a complex activation function of the machine learning model; generating, with at least one processor, an updated machine learning model based on the approximation of the complex activation function; providing, with at least one processor, the updated machine learning model to a plurality of multi-party computation (MPC) nodes, wherein the plurality of MPC nodes perform an inference task using the updated machine learning model as part of an MPC protocol.
Clause 9: The method of any of clause 8, further comprising: providing a result of the inference task using the MPC protocol.
Clause 10: The method of clause 8 or 9, wherein generating the approximation of the complex activation function of the machine learning model comprises: determining a first output of the machine learning model using a first activation function; calculating an approximate error term using an error polynomial based on the first output of the machine learning model, wherein the error polynomial comprises a plurality of spline-based terms; generating an approximation of an output of the machine learning model using a second activation function based on the first output of the machine learning model and the approximate error term; and wherein the first activation function comprises the complex activation function and the second activation function comprises the approximation of a complex activation function of the machine learning model.
Clause 11: The method of any of clauses 8-10, wherein the plurality of spline-based terms comprises a plurality of unevenly spaced 1 dimensional splines.
Clause 12: The method of any of clauses 8-11, wherein calculating the approximate error term comprises: summing the plurality of spline-based terms.
Clause 13: The method of any of clauses 8-12, further comprising: causing an inference task to be performed by the plurality of MPC nodes using the updated machine learning model as part of an MPC protocol.
Clause 14: The method of any of clauses 8-13, further comprising: generating the error polynomial based on the formula:

$$δ ← \frac{{\int }_{s}^{e} P ( x ) * Error ( x , {\hat{F}}_{crude} )}{N}$$

$$c ← s :$$

$$SP ← ∅$$

$$while c < e$$

$${δ}_{crude} ← Error ( P ( x ) , s , c , {\hat{F}}_{crude} )$$

$$if {δ}_{crude} > δ :$$

$${f}_{[ c , e ]} ( x ) ← INTERPOLATE ( [ c , e ] , F , \hat{F} , D )$$

$$SP ← S ( {f}_{[ c . e ]} ( x ) , s , c )$$

$$s ← c$$

$$c ← c + Δ$$

$$return SP$$

wherein: F(x) is a complex activation function; \hat{F}_{crude} is an approximation of F(x); s is a starting point for approximation F(x); e is an ending point for approximation F(x); N is a number of piece-wise polynomials used for approximation; D is a maximum degree of each of N; i is a starting point of a domain of a plurality of domains; j is an ending point of a domain of the plurality of domains; ƒ_{[i,j]}(x) is a polynomial to interpolate the approximate error term between [i,j]; S(ƒ(x)i,j) is a polynomial piece S between point [i,j] with polynomial ƒ(x) of degree at most D; P(x) is a probability distribution of x; Δ is a step size; δ is an approximation error; c is a pointer starting at s, wherein c moves forward by the step size, Δ; and SP is an approximation of the error of \hat{F}_{crude}.
Clause 15: A computer program product comprising a non-transitory computer readable medium comprising one or more instructions that, when executed by at least one processor, cause the at least one processor to: receive data associated with a machine learning model; generate an approximation of a complex activation function of the machine learning model; generate an updated machine learning model based on the approximation of the complex activation function; provide the updated machine learning model to a plurality of multi-party computation (MPC) nodes, wherein the plurality of MPC nodes perform an inference task using the updated machine learning model as part of an MPC protocol.
Clause 16: The computer program product of clause 15, wherein the one or more instructions further cause the at least one processor to: provide a result of the inference task using the MPC protocol.
Clause 17: The computer program product of clause 15 or 16, wherein, the one or more instructions that cause the at least one processor to generate the approximation of the complex activation function of the machine learning model, cause the at least one processor to: determine a first output of the machine learning model using a first activation function; calculate an approximate error term using an error polynomial based on the first output of the machine learning model, wherein the error polynomial comprises a plurality of spline-based terms; generate an approximation of an output of the machine learning model using a second activation function based on the first output of the machine learning model and the approximate error term; and wherein the first activation function comprises the complex activation function and the second activation function comprises the approximation of a complex activation function of the machine learning model.
Clause 18: The computer program product of any of clauses 15-17, wherein the plurality of spline-based terms comprises a plurality of unevenly spaced 1 dimensional splines.
Clause 19: The computer program product of any of clauses 15-18, wherein, the one or more instructions that cause the at least one processor to calculate the approximate error term, cause the at least one processor to: sum the plurality of spline-based terms.
Clause 20: The computer program product of any of clauses 15-19, wherein the one or more instructions further cause the at least one processor to: cause an inference task to be performed by the plurality of MPC nodes using the updated machine learning model as part of an MPC protocol.
Clause 21: The computer program product of any of clauses 15-20, wherein the one or more instructions further cause the at least one processor to: generate the error polynomial based on the formula:

$$δ ← \frac{{\int }_{s}^{e} P ( x ) * Error ( x , {\hat{F}}_{crude} )}{N}$$

$$c ← s :$$

$$SP ← ∅$$

$$while c < e$$

$${δ}_{crude} ← Error ( P ( x ) , s , c , {\hat{F}}_{crude} )$$

$$if {δ}_{crude} > δ :$$

$${f}_{[ c , e ]} ( x ) ← INTERPOLATE ( [ c , e ] , F , \hat{F} , D )$$

$$SP ← S ( {f}_{[ c . e ]} ( x ) , s , c )$$

$$s ← c$$

$$c ← c + Δ$$

$$return SP$$

wherein: F(x) is a complex activation function; \hat{F}_{crude} is an approximation of F(x); s is a starting point for approximation F(x); e is an ending point for approximation F(x); N is a number of piece-wise polynomials used for approximation; D is a maximum degree of each of N; i is a starting point of a domain of a plurality of domains; j is an ending point of a domain of the plurality of domains; ƒ_{[i,j]}(x) is a polynomial to interpolate the approximate error term between [i,j]; S(ƒ(x)i,j) is a polynomial piece S between point [i,j] with polynomial ƒ(x) of degree at most D; P(x) is a probability distribution of x; Δ is a step size; δ is an approximation error; c is a pointer starting at s, wherein c moves forward by the step size, Δ; and SP is an approximation of the error of \hat{F}_{crude}.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for providing secure inference in a multi-party computation (MPC) setting according to some non-limiting embodiments or aspects;

FIG. 2 is a flow diagram of a method for providing secure inference in an MPC setting, according to some non-limiting embodiments or aspects;

FIG. 3 is a flow diagram of a method for authentication of an identity of a user, according to some non-limiting embodiments or aspects;

FIGS. 4A-4F are schematic diagrams of an exemplary implementation of a system and/or method for authentication of an identity of a user according to some non-limiting embodiments or aspects;

FIG. 5 is a diagram of an exemplary environment in which systems, methods, and/or computer program products, described herein, may be implemented, according to some non-limiting embodiments or aspects; and

FIG. 6 is a schematic diagram of example components of one or more devices of FIG. 1 and/or FIG. 5, according to some non-limiting embodiments or aspects.

It should be appreciated by those skilled in the art that any block diagrams herein represent conceptual views of illustrative systems embodying the principles of the present subject matter. Similarly, it may be appreciated that any flow charts, flow diagrams, state transition diagrams, pseudo code, and the like represent various processes which may be substantially represented in a computer readable medium and executed by a computer or processor, whether or not such computer or processor is explicitly shown.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting.

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

Non-limiting embodiments or aspects of the disclosed subject matter are directed to systems, methods, and computer program products for providing secure inference in a multi-party computation (MPC) setting. In some non-limiting embodiments or aspects, a secure inference system may include at least one processor configured to receive data associated with a machine learning model, generate an approximation of a complex (e.g., non-linear) activation function of the machine learning model, generate an updated machine learning model based on the approximation of the complex activation function, and provide the updated machine learning model to a plurality of MPC nodes, wherein the plurality of MPC nodes perform an inference task using the updated machine learning model as part of an MPC protocol. In some non-limiting embodiments, the secure inference system is further configured to provide a result of the inference task to a user device using the MPC protocol.

In some non-limiting embodiments, when generating the approximation of the complex activation function of the machine learning model, the secure inference system is further configured to determine a first output of the machine learning model using a first activation function, calculate an approximate error term using an error polynomial based on the first output of the machine learning model, wherein the error polynomial comprises a plurality of spline-based terms, and generate an approximation of an output of the machine learning model using a second activation function based on the first output of the machine learning model and the approximate error term, and wherein the first activation function includes the complex activation function and the second activation function comprises the approximation of a complex activation function of the machine learning model. In some non-limiting embodiments, the plurality of spline-based terms may include a plurality of unevenly spaced 1 dimensional splines. In some non-limiting embodiments, when calculating the approximate error term, the secure inference system is configured to sum the plurality of spline-based terms.

In some non-limiting embodiments, the secure inference system is further configured to cause an inference task to be performed by the plurality of MPC nodes using the updated machine learning model as part of an MPC protocol.

In some non-limiting embodiments, the secure inference system is further configured to generate the error polynomial based on the formula:

$$δ ← \frac{{\int }_{s}^{e} P ( x ) * Error ( x , {\hat{F}}_{crude} )}{N}$$

$$c ← s :$$

$$SP ← ∅$$

$$while c < e$$

$${δ}_{crude} ← Error ( P ( x ) , s , c , {\hat{F}}_{crude} )$$

$$if {δ}_{crude} > δ :$$

$${f}_{[ c , e ]} ( x ) ← INTERPOLATE ( [ c , e ] , F , \hat{F} , D )$$

$$SP ← S ( {f}_{[ c . e ]} ( x ) , s , c )$$

$$s ← c$$

$$c ← c + Δ$$

$$return SP$$

where F(x) may be a complex activation function; \hat{F}_{crude} may be an approximation of F(x); s may be a starting point for approximation F(x); e may be an ending point for approximation F(x); N may be a number of piece-wise polynomials used for approximation; D may be a maximum degree of each of N; i may be a starting point of a domain of a plurality of domains; j may be an ending point of a domain of the plurality of domains; ƒ_{[i,j]}(x) may be a polynomial to interpolate the approximate error term between [i,j]; S(ƒ(x)i,j) may be a polynomial piece S between point [i,j] with polynomial ƒ(x) of degree at most D; P(x) may be a probability distribution of x; Δ may be a step size; δ may be an approximation error; c may be a pointer starting at s, wherein c moves forward by the step size, Δ; and SP may be an approximation of the error of crude.

In some non-limiting embodiments or aspects, the secure inference system may be configured to approximate the complex activation function, F(x) based on a Gradient free approach. In some non-limiting embodiments, the Gradient free approach may provide advantages with regard to computation resources and accuracy as compared to a Gradient based approach.

In this way, non-limiting embodiments or aspects of the disclosed subject matter provide for machine learning models that are effective at performing inference tasks in a secure setting that uses an MPC protocol. For instance, the secure inference system may provide a machine learning model that includes an approximation of a complex activation function that is configured to perform inference tasks in a secure setting that uses an MPC protocol. In this way, the secure inference system may provide a machine learning model that provides more accurate outputs and/or reduces the amount of network and/or computational resources when performing inference tasks as compared to a machine learning model that has a complex activation function in a secure setting that uses an MPC protocol.

For the purpose of illustration, in the following description, while the presently disclosed subject matter is described with respect to methods, systems, and computer program products for providing secure inference in an MPC setting, such as for authentication of an identity of a user, one skilled in the art will recognize that the disclosed subject matter is not limited to the non-limiting embodiments or aspects disclosed herein. For example, the methods, systems, and computer program products, described herein, may be used with a wide variety of settings where secure inference is desired and/or required, e.g., inferences that provide predictions (e.g., predictions for fraud prevention, predictions used in the prevention of spoofing attacks, etc.), classifications, authorization, authentication, identification, and/or the like.

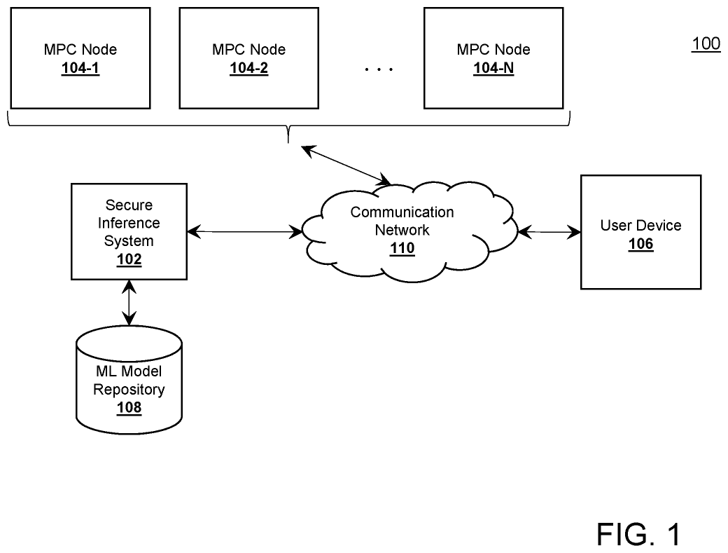

FIG. 1 is a schematic diagram of system 100 for providing secure inference in an MPC setting according to some non-limiting embodiments or aspects. System 100 may include secure inference system 102, MPC node 104-1, MPC node 104-2, MPC node 104-N (referred to individually as MPC node 104 and collectively as MPC nodes 104, where appropriate), user device 106, machine learning (ML) model repository 108, and/or communication network 110. Secure inference system 102 and/or user device 106 may interconnect (e.g., establish a connection to communicate) via wired connections, wireless connections, or a combination of wired and wireless connections.

Secure inference system 102 may include one or more devices configured to communicate with MPC nodes 104, user device 106, and/or ML model repository 108 via communication network 110. For example, secure inference system 102 may include a computing device, such as a server (e.g., a single server), a group of servers, and/or other like devices. In some non-limiting embodiments or aspects, secure inference system 102 may include a processor and/or memory, as described herein. In some non-limiting embodiments or aspects, secure inference system 102 may include one or more software instructions (e.g., one or more software applications) executing on a server (e.g., a single server), a group of servers, a computing device (e.g., a single computing device), a group of computing devices, and/or other like devices. In some non-limiting embodiments or aspects, secure inference system 102 may be configured to perform one or more steps of methods described herein. In some non-limiting embodiments or aspects, secure inference system 102 may be configured to communicate with a data storage device (e.g., ML model repository 108). In some non-limiting embodiments or aspects, secure inference system 102 may be in communication with MPC nodes 104, user device 106, and/or ML model repository 108, such that secure inference system 102 is separate from MPC nodes 104, user device 106, and/or ML model repository 108. In some non-limiting embodiments or aspects, user device 106 and/or ML model repository 108 may be implemented by (e.g., may be part of) secure inference system 102.

Additionally or alternatively, secure inference system 102 may generate (e.g., train, validate, re-train, and/or the like), store, and/or implement (e.g., operate, provide inputs to and/or outputs from, and/or the like) one or more machine learning models. For example, secure inference system 102 may generate one or more machine learning models by fitting (e.g., validating) one or more machine learning models against data used for training (e.g., training data). In some non-limiting embodiments or aspects, secure inference system 102 may generate, store, and/or implement one or more machine learning models that are provided for a real-time environment (e.g., a runtime environment) used for providing inferences (e.g., secure inferences) based on data inputs in a live situation. In some non-limiting embodiments or aspects, secure inference system 102 may be in communication with a data storage device (ML model repository 108), which may be local or remote to secure inference system 102.

MPC node 104 may include one or more devices configured to communicate with secure inference system 102, user device 106, and/or ML model repository 108 via communication network 110. For example, MPC node 104 may include a computing device, such as a server (e.g., a single server), a group of servers, and/or other like devices. In some non-limiting embodiments or aspects, MPC node 104 may include a processor and/or memory, as described herein. In some non-limiting embodiments or aspects, MPC node 104 may include one or more software instructions (e.g., one or more software applications) executing on a server (e.g., a single server), a group of servers, a computing device (e.g., a single computing device), a group of computing devices, and/or other like devices. In some non-limiting embodiments or aspects, MPC node 104 may be configured to perform one or more steps of methods described herein. In some non-limiting embodiments or aspects, MPC node 104 may operate according to one or more MPC protocols. For example, MPC node 104 may execute an MPC protocol to jointly compute a value (e.g., a cryptographic value) that is associated with an inference of a machine learning model. The value may be computed without revealing private information (e.g., information provided as an input, such as an input to compute the value) of an entity (e.g., user device 106, an entity associated with user device 106, etc.).

User device 106 may include one or more devices configured to communicate with secure inference system 102, MPC nodes 104, and/or ML model repository 108 via communication network 110. For example, user device 106 may include a computing device, such as a desktop computer, a portable computer (e.g., tablet computer, a laptop computer, and/or the like), a mobile device (e.g., a cellular phone, a smartphone, a personal digital assistant, a wearable device, and/or the like), and/or other like devices. In some non-limiting embodiments or aspects, user device 106 may be associated with a user (e.g., an individual operating user device 106).

ML model repository 108 may include one or more devices that are capable of being in communication with secure inference system 102, MPC nodes 104, and/or user device 106 via communication network 110. For example, ML model repository 108 may include a computing device, such as a server (e.g., a single server), a group of servers, and/or other like devices. In some non-limiting embodiments or aspects, ML model repository 108 may receive, store, and/or provide (e.g., transmit) one or more machine learning models. In some non-limiting embodiments or aspects, ML model repository 108 may be associated with one or more computing devices providing interfaces, such that a user (e.g., an administrative user, a user using a service account, and/or the like) may interact with ML model repository 108 via the one or more computing devices. ML model repository 108 may be in communication with secure inference system 102, MPC nodes 104, and/or user device 106, such that ML model management repository 108 is separate from secure inference system 102, MPC nodes 104, and/or user device 106. Alternatively, in some non-limiting embodiments or aspects, ML model repository 108 may be implemented by (e.g., may be part of) secure inference system 102 and/or user device 106.

Communication network 110 may include one or more wired and/or wireless networks. For example, communication network 110 may include a cellular network (e.g., a long-term evolution (LTE®) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN) and/or the like), a private network, an ad hoc network, an intranet, the Internet, a fiber optic-based network, a cloud computing network, and/or the like, and/or a combination of some or all of these or other types of networks.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally or alternatively, a set of devices (e.g., one or more devices) of system 100 may perform one or more functions described as being performed by another set of devices of system 100.

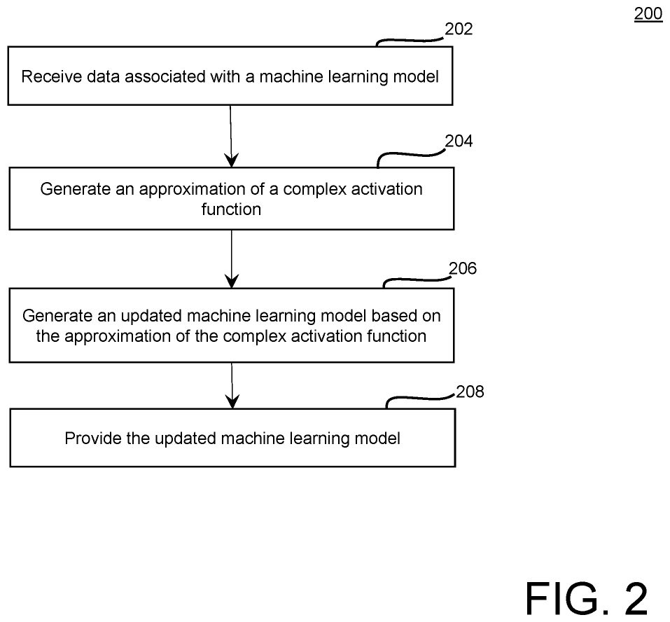

FIG. 2 is a flow diagram of process 200 for providing secure inference in an MPC setting. In some non-limiting embodiments or aspects, one or more steps of process 200 may be performed (e.g., completely, partially, etc.) by secure inference system 102 (e.g., one or more devices of secure inference system 102). In some non-limiting embodiments or aspects, one or more steps of process 300 may be performed (e.g., completely, partially, etc.) by another device or group of devices separate from or including secure inference system 102, such as MPC nodes 104, user device 106, and/or ML model repository 108.

As shown in FIG. 2, at step 202, process 200 includes receiving data associated with a machine learning model. For example, secure inference system 102 may receive data associated with a machine learning model from user device 106 and/or ML model repository 108. In some non-limiting embodiments or aspects, the data associated with a machine learning model may include a complete or a partial copy of a machine learning model. In some non-limiting embodiments, the machine learning model is a trained machine learning model (e.g., a machine learning model that has been trained and validated based on a dataset, such as a trained deep learning neural network (DNN) machine learning model) that is configured to receive an input and provide an inference as an output based on the inference.

In some non-limiting embodiments or aspects, the machine learning model may include a neural network machine learning model, such as a DNN machine learning model. For example, the machine learning models may include a DNN machine learning model having parameters that include a large number of nodes and/or a number of layers (e.g., a number of layers that include input layers, hidden layers, output layers, etc.). In such an example, the DNN machine learning model may include 5 nodes, 10 nodes, 20 nodes, 50 nodes, 100 nodes, 1,000 nodes, and/or the like for one or more layers of the DNN machine learning model. Additionally, the DNN machine learning model may include 2 layers, 3 layers, 4, layers, 5 layers, 10 layers, 20 layers, and/or the like. In some non-limiting embodiments, the DNN machine learning model may have specified parameters based on an inference task for which the DNN machine learning model is configured to provide an output. In some non-limiting embodiments or aspects, the number of nodes may correspond to a number of features that are to be provided as an input to the DNN machine learning model.

In some non-limiting embodiments or aspects, each layer of the DNN machine learning model may include one or more sequential components (e.g., linear, normalization, and/or non-linear components). In some examples, linear, normalization, and non-linear operations may be performed sequentially for each of the one or more layers. In some non-limiting embodiments, a result of a linear operation may be normalized (e.g., by batch or by layer) before a complex activation function (e.g., a non-linear activation function) is applied.

As shown in FIG. 2, at step 204, process 200 includes generating an approximation of a complex activation function. For example, secure inference system 102 may generate an approximation of a complex activation function of the machine learning model. In some non-limiting embodiments, when generating the approximation of the complex activation function of the machine learning model, secure inference system 102 may determine one or more outputs of the machine learning model using a first activation function, calculate an approximate error term (e.g., a density aware approximate error term) using an error polynomial based on the one or more outputs of the machine learning model, and generate an approximation of one or more additional outputs of the machine learning model using a second activation function based on the one or more outputs of the machine learning model and the approximate error term. In some non-limiting embodiments or aspects, secure inference system 102 may approximate a complex activation function based on a number of piece-wise polynomials, N, and a maximum degree, D, of each of the N polynomials.

In some non-limiting embodiments or aspects, the first activation function may include a complex activation function of the machine learning model and/or the second activation function may include the approximation of the complex activation function. In some non-limiting embodiments or aspects, secure inference system 102 may generate the approximation of the complex activation function using an approximation technique that is input density aware and approximates regions with high input probability density and low input probability density. In some non-limiting embodiments or aspects, secure inference system 102 may generate the approximation of the complex activation function by finely approximating regions (e.g., based on a size of spline-based terms, by using a higher amount of spline-based terms) with high input probability density and coarsely approximating regions (e.g., based on a size of spline-based terms, by using a lower amount of spline-based terms) with low input probability density.

In some non-limiting embodiments or aspects, the complex activation function may include a non-linear activation function. For example, the complex activation function may include an ReLU activation function. In some non-limiting embodiments, the complex activation function may include an activation function that is more non-linear than an ReLU activation function. Examples may include highly non-linear activation functions, such as a sigmoid activation function, a TanH activation function, a LeakyReLU activation function, a DyingReLU activation function, a parametric ReLU activation function, an SiLU activation function, a GeLU activation function, a Mish activation function, an ELU activation function, and/or the like.

In some non-limiting embodiments or aspects, secure inference system 102 may generate an error polynomial based on the formula:

$$δ ← \frac{{\int }_{s}^{e} P ( x ) * Error ( x , {\hat{F}}_{crude} )}{N}$$

$$c ← s :$$

$$SP ← ∅$$

$$while c < e$$

$${δ}_{crude} ← Error ( P ( x ) , s , c , {\hat{F}}_{crude} )$$

$$if {δ}_{crude} > δ :$$

$${f}_{[ c , e ]} ( x ) ← INTERPOLATE ( [ c , e ] , F , \hat{F} , D )$$

$$SP ← S ( {f}_{[ c . e ]} ( x ) , s , c )$$

$$s ← c$$

$$c ← c + Δ$$

$$return SP$$

wherein:
   F(x) is a complex activation function;
   \hat{F}_{crude} is an approximation of F(x);
   s is a starting point for approximation F(x);
   e is an ending point for approximation F(x);
   N is a number of piece-wise polynomials used for approximation;
   D is a maximum degree of each of N;
   i is a starting point of a domain of a plurality of domains;
   j is an ending point of a domain of the plurality of domains;
   ƒ_{[i,j]}(x) is a polynomial to interpolate an approximate error term between [i,j];
   S(ƒ(x)i,j) is a polynomial piece S between point [i,j] with polynomial ƒ(x) of degree at most D;
   P(x) is a probability distribution of x;
   Δ is a step size;
   δ is an approximation error;
   c is a pointer starting at s, wherein c moves forward by the step size, Δ; and
   SP is an approximation of the error of \hat{F}_{crude}.

In some non-limiting embodiments or aspects, the complex activation function F(x) may be separately stored (e.g., in a privacy preserving way). Secure inference system 102 may generate an approximation of the complex activation function \hat{F}_{crude} (e.g., an MPC friendly version of the complex activation function) by approximating the complex activation function F(x) using piece-wise linear polynomials.

In some non-limiting embodiments or aspects, secure inference system 102 may generate the approximation of the complex activation function F(x) based on all possible piece-wise linear polynomial approximations. For example, secure inference system 102 may generate the approximation of complex activation function, F(x) by determining an activation function that would minimize an absolute difference between a plaintext inference and a secure inference.

In some non-limiting embodiments or aspects, secure inference system 102 may receive, as an input, the complex activation function F(x). In some non-limiting embodiments or aspects, before or after receiving the complex activation function F(x), secure inference system 102 may receive and/or generate the probability density function of input x (e.g., P(x)). In some non-limiting embodiments or aspects, before or after receiving the complex activation function F(x), secure inference system 102 may receive and/or generate an approximation of the complex activation function \hat{F}_{crude}, where an approximation of the complex activation function \hat{F}_{crude} may include a piece-wise MPC friendly simple but crude approximation including a high approximation error δ_{crude}.

In some non-limiting embodiments or aspects, in a similar fashion as described above, secure inference system 102 may generate an approximation of a sigmoid activation function based on the following:

$${\hat{f}}_{crude}^{sigmoid} = max ( 0 , min ( \frac{x}{3} , \frac{1}{2} ) )$$

In some non-limiting embodiments or aspects, in a similar fashion as described above, secure inference system 102 may generate approximations of an SiLU activation function and/or a GeLU activation function, respectively, based on the following:

$${\hat{f}}_{crude}^{SiLU} = x \cdot \{ max ( 0 , min ( \frac{x}{3} , \frac{1}{2} ) ) \}$$

$${\hat{f}}_{crude}^{GeLU} = \frac{x}{1.702} \cdot \{ max ( 0 , min ( \frac{x}{1.702} , \frac{1}{2} ) ) \}$$

In some non-limiting embodiments or aspects, an approximation of the complex activation function \hat{F}_{crude} may be within a domain [s,e]. Further, the approximation of the complex activation function \hat{F}_{crude} may be outside of the domain [s,e] when the approximation of the complex activation function \hat{F}_{crude} has an approximation error value of almost zero (e.g., within a threshold value of zero). In some non-limiting embodiments or aspects, secure inference system 102 may reduce δ_{crude} for x∈[s,e] via a set of N interpolated splines SP=[S1, S2, . . . , SN] covering the input domain x∈[s,e]. In some non-limiting embodiments or aspects, each interpolated spline Sᵢ may approximate the domain [i,j] via a polynomial ƒ(x) of a maximum degree D, where D is represented by <ƒ(x), i, j>. In some non-limiting embodiments or aspects, SP may be an approximation of the approximation error of crude. In some non-limiting embodiments or aspects, secure inference system 102 may generate an improved MPD friendly approximation of the complex activation function F(x) represented by F_{improved}. In some non-limiting embodiments or aspects, F_{improved} may closely approximate the complex activation function F(x).

In some non-limiting embodiments or aspects, secure inference system 102 may calculate F_{improved} based on the following equation, where bᵢ=1 if x∈[sᵢ, eᵢ], and otherwise, bᵢ=0:

$${\hat{F}}_{crude} + {\sum }_{1}^{N} {b}_{i} \cdot {f}_{i} ( x )$$

In some non-limiting embodiments or aspects, secure inference system 102 may compute (e.g., generate) the set N of interpolated splines SP (e.g., N number of splines SP). For example, secure inference system 102 may determine the approximate error term of N polynomial splines of degree D covering [s,e]. In some non-limiting embodiments or aspects, secure inference system 102 may maintain a pointer c which may start at a point s and, at each step, move in a direction toward e by a step size A until the crude approximation error δ_{crude} from [s,c] is a value greater than a value of an approximate error threshold δ.

In some non-limiting embodiments or aspects, secure inference system 102 may use the probability density of the input P(x) to calculate the crude approximation error δ_{crude}. For example, secure inference system 102 may use the probability density of the input P(x) on regions in which there is a high probability of the occurrence of an approximation error to calculate the crude approximation error δ_{crude}.

In some non-limiting embodiments or aspects, in a case where δ_{crude} from [s,c] is a value greater than a value of an approximate error threshold δ, secure inference system 102 may interpolate the approximation via a polynomial spline ƒ(x) and add the spline S(ƒ(x),s,c) to SP to reduce the approximate error and/or to reduce the crude approximate error. In some non-limiting embodiments or aspects, secure inference system 102 may repeat the same procedure for one or more values of s and c. Secure inference system 102 may end the repetition (e.g., stop) when a value of c is equal to a value of e (e.g., when c reaches e), at which point secure inference system 102 may assign the last spline and add the last spline to SP. In some non-limiting embodiments or aspects, secure inference system 102 may set the value of error threshold δ in such a way so that a total number of splines does not exceed N.

In some non-limiting embodiments or aspects, secure inference system 102 may calculate a density aware approximate error term based on the following error function:

$$Input \text{:} [ s , e ] ; F ( x ) ; \hat{F} ( x ) ; D$$

$$Output \text{:} δ$$

$$δ ← \int P ( x ) \cdot \vert F ( x ) - \hat{F} ( x ) \vert$$

$$Return δ$$

In some non-limiting embodiments or aspects, secure inference system 102 may determine a density of the input. For example, secure inference system 102 may determine one or more areas of the input where the density is above a threshold value (e.g., high). Secure inference system 102 may be configured to minimize errors for those areas where input density is high in order to ensure a low approximation error when errors are summed over for a fixed number of polynomials.

In some non-limiting embodiments or aspects, the error polynomial may include a piece-wise polynomial. The piece-wise polynomial may be designed to be computed securely using MPC libraries that support (e.g., only support) math operations including addition (“ADD”) (+), multiplication (“MUL”) (x), and/or compare (“COMP”) (>).

In some non-limiting embodiments or aspects, the error polynomial may include a plurality of spline-based terms. In some non-limiting embodiments or aspects, the plurality of spline-based terms comprises a plurality of unevenly spaced splines. In one example, the plurality of spline-based terms comprises a plurality of unevenly spaced 1 dimensional splines.

In some non-limiting embodiments or aspects, when calculating an approximate error term using the error polynomial, secure inference system 102 may sum the plurality of spline-based terms to provide a result. In some non-limiting embodiments or aspects, secure inference system 102 may add the result of the summation of the plurality of spline-based terms.

As shown in FIG. 2, at step 206, process 200 includes generating an updated machine learning model based on the approximation of the complex activation function. For example, secure inference system 102 may generate an updated machine learning model based on the approximation of the complex activation function. In some non-limiting embodiments or aspects, the updated machine learning model may include the approximation of the complex activation function as a replacement for the complex activation function.

As shown in FIG. 2, at step 208, process 200 includes providing the updated machine learning model. For example, secure inference system 102 may provide the updated machine learning model to MPC nodes 104. In some non-limiting embodiments or aspects, each MPC node 104 of MPC nodes 104 may perform an inference task using the updated machine learning model as part of an MPC protocol. In some non-limiting embodiments or aspects, secure inference system 102 may cause an inference task to be performed by the plurality of MPC nodes using the updated machine learning model as part of an MPC protocol.

In some non-limiting embodiments or aspects, each MPC node 104 of MPC nodes 104 may provide (e.g., to user device 106) a result of the inference task using the MPC protocol. In some non-limiting embodiments or aspects, secure inference system 102 may cause MPC nodes 104 to provide (e.g., to user device 106) the result of the inference task using the MPC protocol.

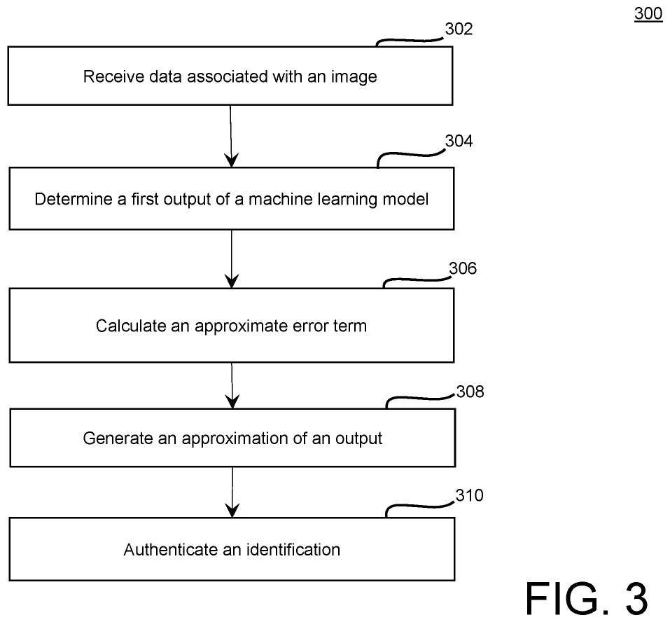

FIG. 3 is a flow diagram of process 300 for authenticating identification of a user according to some non-limiting embodiments or aspects. In some non-limiting embodiments or aspects, one or more steps of process 300 may be performed (e.g., completely, partially, etc.) by secure inference system 102 (e.g., one or more devices of secure inference system 102). In some non-limiting embodiments or aspects, one or more steps of process 300 may be performed (e.g., completely, partially, etc.) by another device or group of devices separate from or including secure inference system 102, such as MPC nodes 104, user device 106, and/or ML model repository 108.

As shown in FIG. 3, at step 302, process 300 includes receiving data associated with an image. For example, secure inference system 102 may receive data associated with an image from user device 106. In some non-limiting embodiments or aspects, secure inference system 102 may receive data (e.g., data associated with an image) in the same or similar fashion as described herein. In some non-limiting embodiments or aspects, secure inference system 102 may receive data associated with an image from user device 106. For example, secure inference system 102 may receive data associated with an image from user device 106 as part of an MPC protocol to protect a user's privacy. In some non-limiting embodiments or aspects, the at least two servers may perform joint computation of the data associated with the image prior to transmitting the data associated with the image to secure inference system 102.

In some non-limiting embodiments or aspects, biometric data of the user may be captured and/or transmitted via user device 106. For example, user device 106 may capture biometric data of the user and transmit the captured biometric data of the user to secure inference system 102.

In some non-limiting embodiments or aspects, capturing the biometric data of the user may include capturing image data associated with a facial image of the user, a fingerprint image of the user, an eye image of the user, and/or any combination thereof. In some non-limiting embodiments or aspects, user device 106 may capture image data associated with a facial image of the user, a fingerprint image of the user, an eye image of the user, and/or any combination thereof and transmit the image data associated with a facial image of the user, a fingerprint image of the user, an eye image of the user, and/or any combination thereof to secure inference system 102.

As shown in FIG. 3, at step 304, process 300 includes determining a first output of a machine learning model. For example, secure inference system 102 may determine the first output of the machine learning model. In some non-limiting embodiments or aspects, secure inference system 102 may determine an output of a machine learning model in the same or similar fashion as described herein. In some non-limiting embodiments or aspects, secure inference system 102 may determine the first output of the machine learning model using a first activation function based on the data associated with the image of the user.

In some non-limiting embodiments or aspects, the machine learning model may be a trained DNN machine learning model. Additionally or alternatively, secure inference system 102 may generate (e.g., train, validate, re-train, and/or the like) the machine learning model. In some non-limiting embodiments or aspects, secure inference system 102 may generate the machine learning model by inputting data (e.g., data associated with a plurality of images). In some non-limiting embodiments or aspects, the machine learning model may be trained to perform a task. In some non-limiting embodiments or aspects, the task may be to authenticate a user based on the data associated with the image of the user received from the user device.

In some non-limiting embodiments or aspects, the machine learning model may include a plurality of layers (e.g., network layers). In some non-limiting embodiments or aspects, a different activation function may be embedded in each layer of the plurality of layers of the machine learning model. In some non-limiting embodiments or aspects, secure inference system 102 may determine an output for the machine learning model for each different activation function embedded in each layer of the plurality of layers.

As shown in FIG. 3, at step 306, process 300 includes calculating an approximate error term. For example, secure inference system 102 may calculate the approximate error term. In some non-limiting embodiments or aspects, secure inference system 102 may calculate the approximate error term in the same or similar fashion as described herein. In some non-limiting embodiments or aspects, secure inference system 102 may calculate the approximate error term using an error polynomial based on the first output of the machine learning model. In some non-limiting embodiments or aspects, secure inference system 102 may automatically calculate the approximate error term based on the first output of the machine learning model.

In some non-limiting embodiments or aspects, the error polynomial may include a plurality of spline-based terms. In some non-limiting embodiments or aspects, each of the plurality of spline-based terms may include a domain of a plurality of domains.

In some non-limiting embodiments or aspects, the plurality of domains of the plurality of spline-based terms may be uneven. For example, a first domain of the plurality of domains may be a first size. A second domain of the plurality of domains may be a second size, where the second size is smaller than the first size.

In some non-limiting embodiments or aspects, secure inference system 102 may generate the error polynomial. For example, secure inference system 102 may generate the error polynomial based on:

$$δ ← \frac{{\int }_{s}^{e} P ( x ) * Error ( x , {\hat{F}}_{crude} )}{N}$$

$$c ← s :$$

$$SP ← ∅$$

$$while c < e$$

$${δ}_{crude} ← Error ( P ( x ) , s , c , {\hat{F}}_{crude} )$$

$$if {δ}_{crude} > δ :$$

$${f}_{[ c , e ]} ( x ) ← INTERPOLATE ( [ c , e ] , F , \hat{F} , D )$$

$$SP ← S ( {f}_{[ c . e ]} ( x ) , s , c )$$

$$s ← c$$

$$c ← c + Δ$$

$$return SP$$

In some non-limiting embodiments or aspects, F(x) may be a complex activation (e.g., a non-liner activation) function; \hat{F}_{crude} may be an approximation of F(x); s may be a starting point for approximation F(x); e may be an ending point for approximation F(x); N may be a number of piece-wise polynomials used for approximation; D may be a maximum degree of each of N; i may be a starting point of a domain of a plurality of domains; j may be an ending point of a domain of the plurality of domains; ƒ_{[i,j]}(x) may be a polynomial to interpolate the approximate error term between [i,j]; S(ƒ(x)i,j) may be a polynomial piece S between point [i,j] with polynomial ƒ(x) of degree at most D; P(x) may be a probability distribution of x; Δ may be a step size; δ is an approximation error; c may be a pointer starting at s, wherein c moves forward by the step size, Δ; and SP may be an approximation of the error of \hat{F}_{crude}.

In some non-limiting embodiments or aspects, calculating the approximate error term may include summing (e.g., adding up) the plurality of spline-based terms. For example, secure inference system 102 may calculate (e.g., automatically) the approximate error term by summing two or more of the plurality of spline-based terms. In some non-limiting embodiments or aspects, secure inference system 102 may determine values for parameters, such as the number of piece-wise polynomials used for approximation, and a maximum degree of each of the piece-wise polynomials, for the complex activation function, F(x), based on a Gradient free approach.

As shown in FIG. 3, at step 308, process 300 includes generating an approximation of an output. For example, secure inference system 102 may generate an approximation of an output. In some non-limiting embodiments or aspects, secure inference system 102 may generate an approximation of an output of a machine learning model using a second activation function in the same or similar fashion as described herein. In some non-limiting embodiments or aspects, secure inference system 102 may generate the approximation of the output of the machine learning model using a second activation function based on the first output of the machine learning model and/or the approximate error term. In some non-limiting embodiments or aspects, secure inference system 102 may automatically generate the approximation of the output of the second activation function based on the first output of the machine learning model and/or the approximate error term. In some non-limiting embodiments or aspects, generating the approximation of the output of the second activation function may include summing (e.g., adding up), by secure inference system 102, the first output of the machine learning model and the approximate error term.

As shown in FIG. 3, at step 310, process 300 includes authenticating an identification. For example, secure inference system 102 may authenticate an identification of a user. In some non-limiting embodiments or aspects, secure inference system 102 may authenticate an identification of a user based on the approximation of the output of the second activation function. In some non-limiting embodiments or aspects, secure inference system 102 may automatically authenticate an identification of a user based on the approximation of the output of the second activation function. In some non-limiting embodiments or aspects, secure inference system 102 may determine whether to authenticate or not authenticate a user based on the approximation of the output of the second activation function.

In this way, non-limiting embodiments or aspects of process 300 authenticates users and prevents spoofing attacks by using the MPC protocols that are secure and preserve the privacy of a user's biometric data. Additionally, non-limiting embodiments or aspects of process 300 reduces system latency without affecting an accuracy (e.g., detection accuracy) of the MPC protocols.

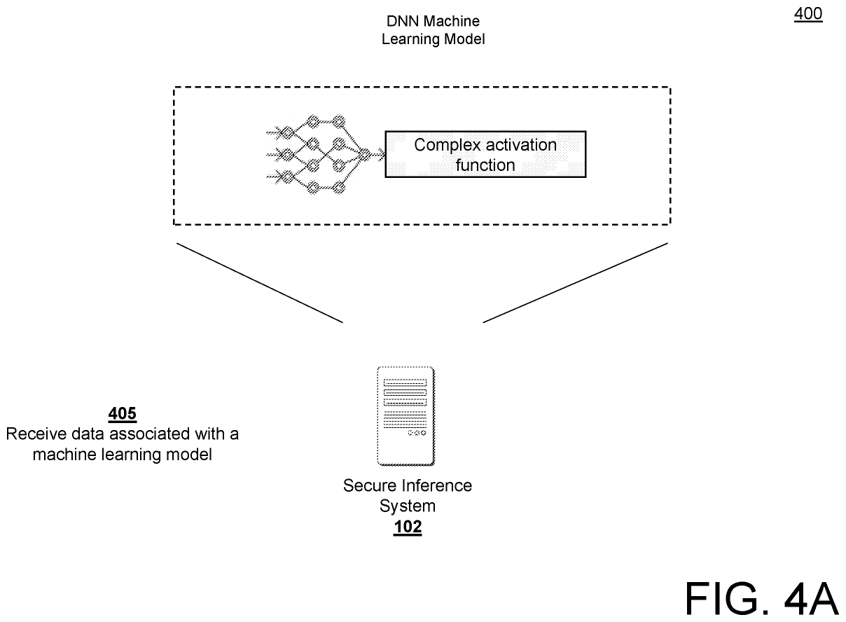

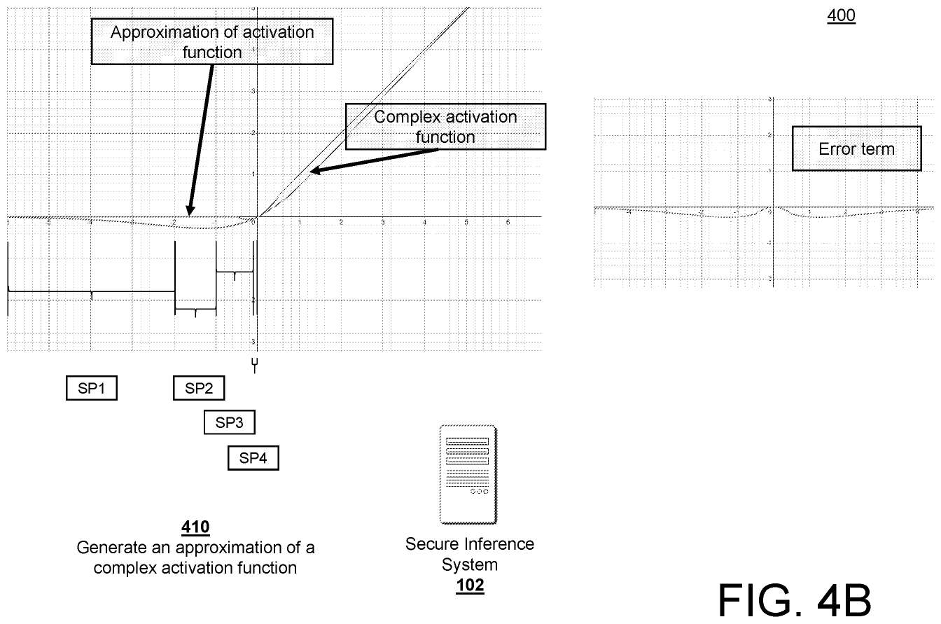

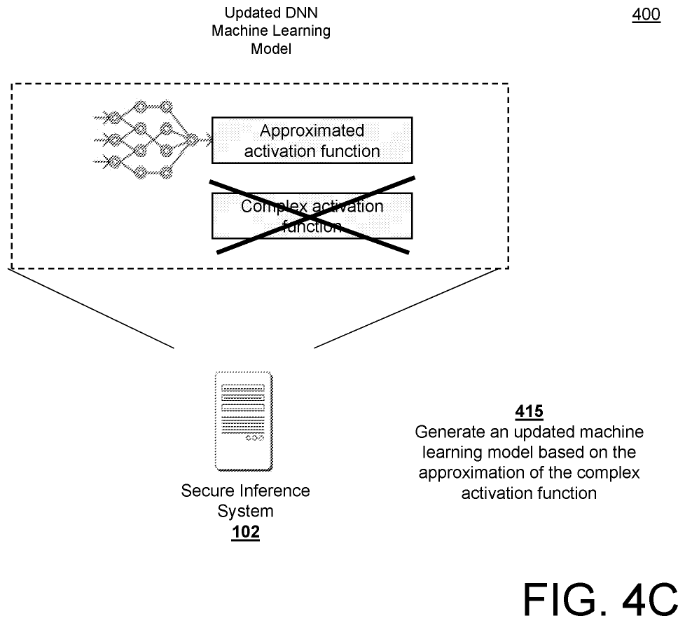

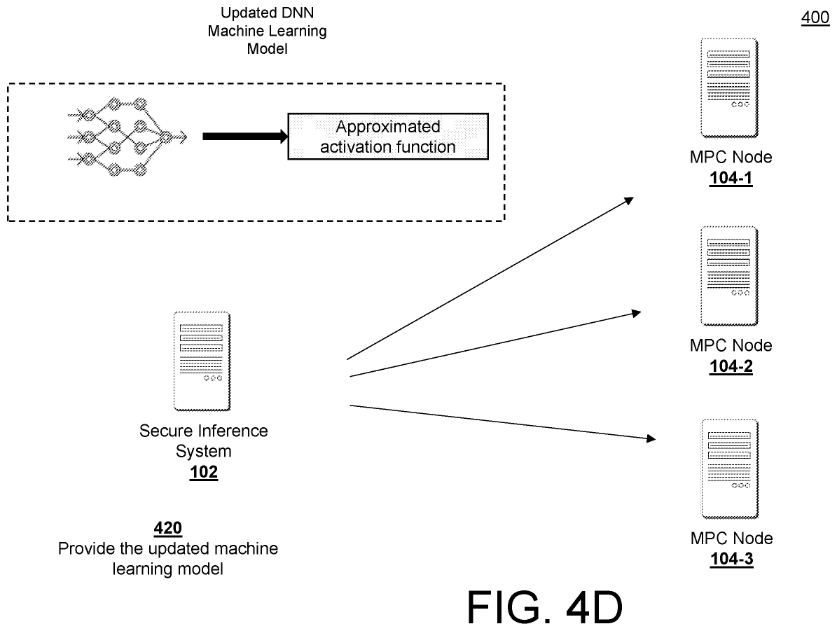

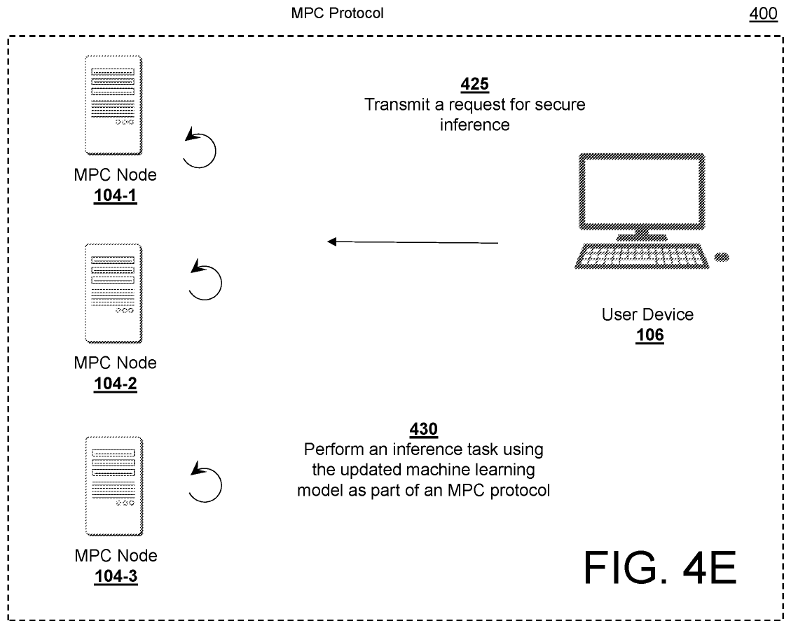

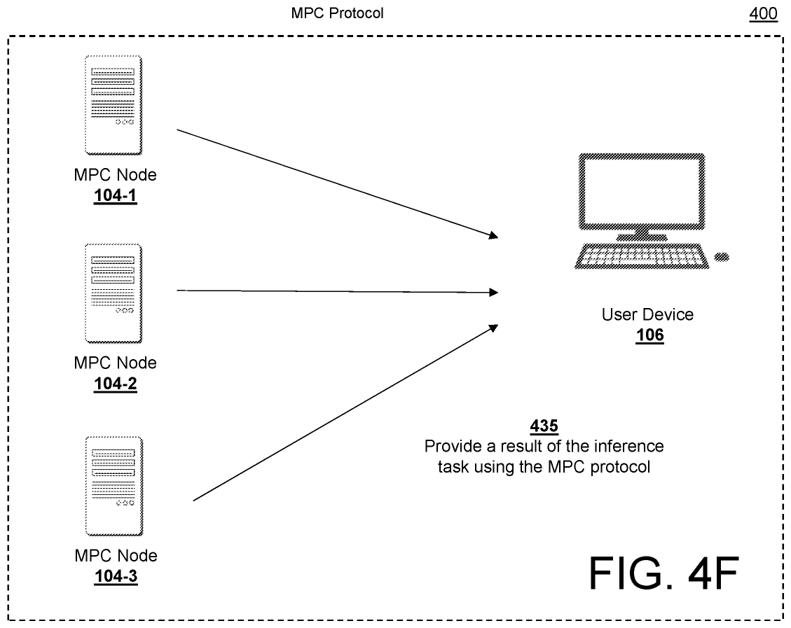

Referring now to FIGS. 4A-4F, FIGS. 4A-4F are diagrams of a non-limiting embodiment or aspect of implementation 400 relating to a process (e.g., process 200 and process 300) for providing secure inference in an MPC setting. In some non-limiting embodiments or aspects, one or more of the steps of the process may be performed (e.g., completely, partially, etc.) by secure inference system 102 (e.g., one or more devices of secure inference system 102). In some non-limiting embodiments or aspects, one or more of the steps of the process may be performed (e.g., completely, partially, etc.) by another device or a group of devices separate from or including secure inference system 102 (e.g., one or more devices of secure inference system 102), MPC nodes 104, user device 106, and/or ML model repository 108 (e.g., one or more devices of ML model repository 108).

As shown by reference number 405 in FIG. 4A, secure inference system 102 may receive data associated with a machine learning model. In one example, secure inference system 102 may receive data associated with a machine learning model from user device 106 and/or ML model repository 108. In some non-limiting embodiments or aspects, the machine learning model is a trained DNN machine learning model (e.g., a DNN machine learning model that has been trained and validated based on a dataset, such as a trained DNN machine learning model), that is configured to receive an input and provide an inference as an output based on the inference.

As shown by reference number 410 in FIG. 4B, secure inference system 102 may generate an approximation of a complex activation function. For example, secure inference system 102 may generate an approximation of a complex activation function of the machine learning model. In some non-limiting embodiments or aspects, when generating the approximation of the complex activation function of the machine learning model, secure inference system 102 may determine one or more outputs of the machine learning model using a first activation function, calculate an approximate error term (e.g., a density aware approximate error term) using an error polynomial based on the one or more outputs of the machine learning model, and generate an approximation of one or more additional outputs of the machine learning model using a second activation function based on the one or more outputs of the machine learning model and the approximate error term.

In some non-limiting embodiments or aspects, the error polynomial may include a plurality of spline-based terms (e.g., shown as “SP1,” “SP2,” “SP3,” and “SP4”). In some non-limiting embodiments or aspects, the plurality of spline-based terms include a plurality of unevenly spaced 1 dimensional splines. In some non-limiting embodiments or aspects, the plurality of spline-based terms may include a number of piece-wise polynomials, N, having a maximum degree, D, for each of the N polynomials.

As shown by reference number 415 in FIG. 4C, secure inference system 102 may generate an updated machine learning model based on the approximation of the complex activation function. For example, the updated machine learning model may include the approximation of the complex activation function as a replacement for the complex activation function.

As shown by reference number 420 in FIG. 4D, secure inference system 102 may provide the updated machine learning model to MPC nodes 104-1, 104-2, and 104-3.

As shown by reference number 425 in FIG. 4E, user device 106 may transmit a request for secure inference to MPC nodes 104-1, 104-2, and 104-3. In some non-limiting embodiments or aspects, the request for secure inference may include a request for a specific inference task to be performed. As shown by reference number 430 in FIG. 4E, MPC nodes 104-1, 104-2, and 104-3 may perform an inference task using the updated machine learning model as part of an MPC protocol.

As shown by reference number 435 in FIG. 4F, MPC nodes 104-1, 104-2, and 104-3 may provide a result of the inference task to user device 106 using the MPC protocol. In some non-limiting embodiments or aspects, the result of the inference task may be based on a number of MPC nodes 104-1, 104-2, and 104-3 that provide a response (e.g., an output) that is the same as other MPC nodes 104-1, 104-2, and 104-3. In one example, unless all MPC nodes 104-1, 104-2, and 104-3 provide the same response, the result of the inference task may be considered to be corrupt. In another example, if a majority of MPC nodes 104-1, 104-2, and 104-3 provide the same response, the result of the inference task may be considered to be acceptable (e.g., not corrupt).

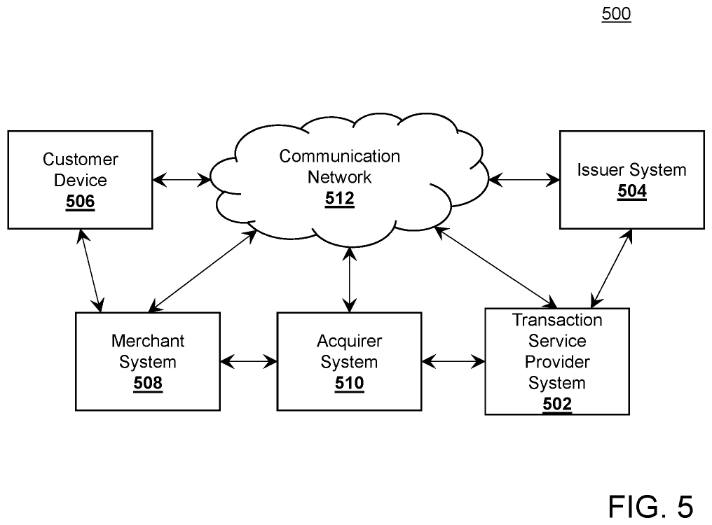

Referring now to FIG. 5, FIG. 5 is a diagram of a non-limiting embodiment or aspect of an exemplary environment 500 in which systems, products, and/or methods, as described herein, may be implemented. As shown in FIG. 5, environment 500 may include transaction service provider system 502, issuer system 504, customer device 506, merchant system 508, acquirer system 510, and communication network 512. In some non-limiting embodiments or aspects, each of secure inference system 102, user device 106, and/or ML model management repository 108 may be implemented by (e.g., part of) transaction service provider system 502. In some non-limiting embodiments or aspects, at least one of secure inference system 102, MPC node 104, user device 106, and/or ML model repository 108 may be implemented by (e.g., part of) another system, another device, another group of systems, or another group of devices, separate from or including transaction service provider system 502, such as issuer system 504, customer device 506, merchant system 508, acquirer system 510, and/or the like.

Transaction service provider system 502 may include one or more devices capable of receiving information from and/or communicating information to issuer system 504, customer device 506, merchant system 508, and/or acquirer system 510 via communication network 512. For example, transaction service provider system 502 may include a computing device, such as a server (e.g., a transaction processing server), a group of servers, and/or other like devices. In some non-limiting embodiments or aspects, transaction service provider system 502 may be associated with a transaction service provider, as described herein. In some non-limiting embodiments or aspects, transaction service provider system 502 may be in communication with a data storage device, which may be local or remote to transaction service provider system 502. In some non-limiting embodiments or aspects, transaction service provider system 502 may be capable of receiving information from, storing information in, communicating information to, or searching information stored in the data storage device.

Issuer system 504 may include one or more devices capable of receiving information and/or communicating information to transaction service provider system 502, customer device 506, merchant system 508, and/or acquirer system 510 via communication network 512. For example, issuer system 504 may include a computing device, such as a server, a group of servers, and/or other like devices. In some non-limiting embodiments or aspects, issuer system 504 may be associated with an issuer institution, as described herein. For example, issuer system 504 may be associated with an issuer institution that issued a credit account, debit account, credit card, debit card, and/or the like, to a user associated with customer device 506.

Customer device 506 may include one or more devices capable of receiving information from and/or communicating information to transaction service provider system 502, issuer system 504, merchant system 508, and/or acquirer system 510 via communication network 512. Additionally or alternatively, each customer device 506 may include a device capable of receiving information from and/or communicating information to other customer devices 506 via communication network 512, another network (e.g., an ad hoc network, a local network, a private network, a virtual private network, and/or the like), and/or any other suitable communication technique. For example, customer device 506 may include a client device and/or the like. In some non-limiting embodiments or aspects, customer device 506 may or may not be capable of receiving information (e.g., from merchant system 508 or from another customer device 506) via a short-range wireless communication connection (e.g., an NFC communication connection, an RFID communication connection, a Bluetooth® communication connection, a Zigbee® communication connection, and/or the like), and/or communicating information (e.g., to merchant system 508) via a short-range wireless communication connection.

Merchant system 508 may include one or more devices capable of receiving information from and/or communicating information to transaction service provider system 502, issuer system 504, customer device 506, and/or acquirer system 510 via communication network 512. Merchant system 508 may also include a device capable of receiving information from customer device 506 via communication network 512, a communication connection (e.g., an NFC communication connection, an RFID communication connection, a Bluetooth® communication connection, a Zigbee® communication connection, and/or the like) with customer device 506, and/or the like, and/or communicating information to customer device 506 via communication network 512, the communication connection, and/or the like. In some non-limiting embodiments or aspects, merchant system 508 may include a computing device, such as a server, a group of servers, a client device, a group of client devices, and/or other like devices. In some non-limiting embodiments or aspects, merchant system 508 may be associated with a merchant, as described herein. In some non-limiting embodiments or aspects, merchant system 508 may include one or more client devices. For example, merchant system 508 may include a client device that allows a merchant to communicate information to transaction service provider system 502. In some non-limiting embodiments or aspects, merchant system 508 may include one or more devices, such as computers, computer systems, and/or peripheral devices capable of being used by a merchant to conduct a transaction with a user. For example, merchant system 508 may include a point-of-sale (POS) device and/or a point-of-sale (POS) system.

Acquirer system 510 may include one or more devices capable of receiving information from and/or communicating information to transaction service provider system 502, issuer system 504, customer device 506, and/or merchant system 508 via communication network 512. For example, acquirer system 510 may include a computing device, a server, a group of servers, and/or the like. In some non-limiting embodiments or aspects, acquirer system 510 may be associated with an acquirer, as described herein.

Communication network 512 may include one or more wired and/or wireless networks. For example, communication network 512 may include a cellular network (e.g., a long-term evolution (LTE®) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

The number and arrangement of systems, devices, and/or networks shown in FIG. 5 are provided as an example. There may be additional systems, devices, and/or networks; fewer systems, devices, and/or networks; different systems, devices, and/or networks; and/or differently arranged systems, devices, and/or networks than those shown in FIG. 5. Furthermore, two or more systems or devices shown in FIG. 5 may be implemented within a single system or device, or a single system or device shown in FIG. 5 may be implemented as multiple, distributed systems or devices. Additionally or alternatively, a set of systems (e.g., one or more systems) or a set of devices (e.g., one or more devices) of environment 500 may perform one or more functions described as being performed by another set of systems or another set of devices of environment 500.

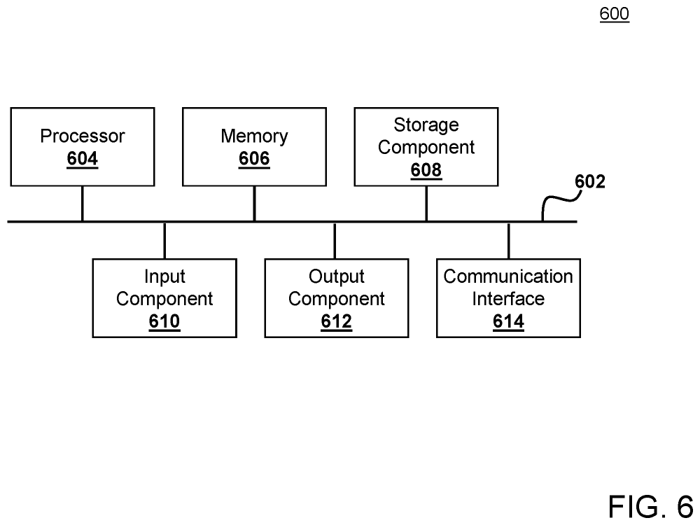

Referring now to FIG. 6, shown is a diagram of example components of a device 600, according to non-limiting embodiments or aspects. Device 600 may correspond to at least one of secure inference system 102, MPC node 104, user device 106, and/or ML model repository 108 in FIG. 1 and/or at least one of transaction service provider system 502, issuer system 504, customer device 506, merchant system 508, and/or acquirer system 510 in FIG. 5, as an example. In some non-limiting embodiments or aspects, such systems or devices in FIG. 1 or FIG. 5 may include at least one device 600 and/or at least one component of device 600. The number and arrangement of components shown in FIG. 6 are provided as an example. In some non-limiting embodiments or aspects, device 600 may include additional components, fewer components, different components, or differently arranged components than those shown in FIG. 6. Additionally or alternatively, a set of components (e.g., one or more components) of device 600 may perform one or more functions described as being performed by another set of components of device 600.

As shown in FIG. 6, device 600 may include bus 602, processor 604, memory 606, storage component 608, input component 610, output component 612, and communication interface 614. Bus 602 may include a component that permits communication among the components of device 600. In some non-limiting embodiments or aspects, processor 604 may be implemented in hardware, firmware, or a combination of hardware and software. For example, processor 604 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed perform a function. Memory 606 may include random access memory (RAM), read only memory (ROM), and/or another type of dynamic or static storage device (e.g., flash memory, magnetic memory, optical memory, etc.) that stores information and/or instructions for use by processor 604. In some non-limiting embodiments or aspects, memory 606 may be the same as or similar to ML model repository 108.

With continued reference to FIG. 6, storage component 608 may store information and/or software related to the operation and use of device 600. For example, storage component 608 may include a hard disk (e.g., a magnetic disk, an optical disk, a magneto-optic disk, a solid state disk, etc.) and/or another type of computer-readable medium. In some non-limiting embodiments or aspects, storage component 608 may be the same as or similar to ML model repository 108. Input component 610 may include a component that permits device 600 to receive information, such as via user input (e.g., a touch screen display, a keyboard, a keypad, a mouse, a button, a switch, a microphone, etc.). Additionally or alternatively, input component 610 may include a sensor for sensing information (e.g., a global positioning system (GPS) component, an accelerometer, a gyroscope, an actuator, etc.). Output component 612 may include a component that provides output information from device 600 (e.g., a display, a speaker, one or more light-emitting diodes (LEDs), etc.). Communication interface 614 may include a transceiver-like component (e.g., a transceiver, a separate receiver and transmitter, etc.) that enables device 600 to communicate with other devices, such as via a wired connection, a wireless connection, or a combination of wired and wireless connections. Communication interface 614 may permit device 600 to receive information from another device and/or provide information to another device. For example, communication interface 614 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 600 may perform one or more processes described herein. Device 600 may perform these processes based on processor 604 executing software instructions stored by a computer-readable medium, such as memory 606 and/or storage component 608. A computer-readable medium may include any non-transitory memory device. A memory device includes memory space located inside of a single physical storage device or memory space spread across multiple physical storage devices. Software instructions may be read into memory 606 and/or storage component 608 from another computer-readable medium or from another device via communication interface 614. When executed, software instructions stored in memory 606 and/or storage component 608 may cause processor 604 to perform one or more processes described herein. Additionally or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A system comprising at least one processor, wherein the at least one processor is configured to:
receive data associated with a machine learning model;
generate an approximation of a complex activation function of the machine learning model;
generate an updated machine learning model based on the approximation of the complex activation function; and
provide the updated machine learning model to a plurality of multi-party computation (MPC) nodes, wherein the plurality of MPC nodes perform an inference task using the updated machine learning model as part of an MPC protocol.

2. The system of claim 1, wherein the at least one processor is further configured to:
provide a result of the inference task using the MPC protocol.

3. The system of claim 1, wherein, when generating the approximation of the complex activation function of the machine learning model, the at least one processor is further configured to:
determine a first output of the machine learning model using a first activation function;
calculate an approximate error term using an error polynomial based on the first output of the machine learning model, wherein the error polynomial comprises a plurality of spline-based terms; and
generate an approximation of an output of the machine learning model using a second activation function based on the first output of the machine learning model and the approximate error term; and
wherein the first activation function comprises the complex activation function and the second activation function comprises the approximation of a complex activation function of the machine learning model.

4. The system of claim 3, wherein the plurality of spline-based terms comprises a plurality of unevenly spaced 1 dimensional splines.

5. The system of claim 1, wherein, when calculating an approximate error term, the at least one processor is configured to:
sum a plurality of spline-based terms.

6. The system of claim 1, wherein the at least one processor is further configured to:
cause the inference task to be performed by the plurality of MPC nodes using the updated machine learning model as part of the MPC protocol.

7. The system of claim 1, wherein the at least one processor is further configured to:
generate an error polynomial based on a formula:
$$δ ← \frac{{\int }_{s}^{e} P ( x ) * Error ( x , {\hat{F}}_{crude} )}{N}$$
$$c ← s :$$
$$SP ← ∅$$
$$while c < e$$
$${δ}_{crude} ← Error ( P ( x ) , s , c , {\hat{F}}_{crude} )$$
$$if {δ}_{crude} > δ :$$
$${f}_{[ c , e ]} ( x ) ← INTERPOLATE ( [ c , e ] , F , \hat{F} , D )$$
$$SP ← S ( {f}_{[ c . e ]} ( x ) , s , c )$$
$$s ← c$$
$$c ← c + Δ$$
$$return SP$$
wherein:
F(x) is a complex activation function;
\hat{F}_{crude} is an approximation of F(x);
s is a starting point for approximation F(x);
e is an ending point for approximation F(x);
N is a number of piece-wise polynomials used for approximation;
D is a maximum degree of each of N;
i is a starting point of a domain of a plurality of domains;
j is an ending point of a domain of the plurality of domains;
ƒ_{[i,j]}(x) is a polynomial to interpolate an approximate error term between [i,j];
S(ƒ(x)i,j) is a polynomial piece S between point [i,j] with polynomial ƒ(x) of degree at most D;
P(x) is a probability distribution of x;
Δ is a step size;
δ is an approximation error;
c is a pointer starting at s, wherein c moves forward by the step size, Δ; and
SP is an approximation of the error of \hat{F}_{crude}.

8. A method, comprising:
receiving, with at least one processor, data associated with a machine learning model;
generating, with at least one processor, an approximation of a complex activation function of the machine learning model;
generating, with at least one processor, an updated machine learning model based on the approximation of the complex activation function; and
providing, with at least one processor, the updated machine learning model to a plurality of multi-party computation (MPC) nodes, wherein the plurality of MPC nodes perform an inference task using the updated machine learning model as part of an MPC protocol.

9. The method of claim 8, further comprising:
providing a result of the inference task using the MPC protocol.

10. The method of claim 8, wherein generating the approximation of the complex activation function of the machine learning model comprises:
determining a first output of the machine learning model using a first activation function;
calculating an approximate error term using an error polynomial based on the first output of the machine learning model, wherein the error polynomial comprises a plurality of spline-based terms; and
generating an approximation of an output of the machine learning model using a second activation function based on the first output of the machine learning model and the approximate error term; and
wherein the first activation function comprises the complex activation function and the second activation function comprises the approximation of a complex activation function of the machine learning model.

11. The method of claim 10, wherein the plurality of spline-based terms comprises a plurality of unevenly spaced 1 dimensional splines.

12. The method of claim 8, wherein calculating an approximate error term comprises:
summing a plurality of spline-based terms.

13. The method of claim 8, further comprising:
causing the inference task to be performed by the plurality of MPC nodes using the updated machine learning model as part of the MPC protocol.

14. The method of claim 8, further comprising:
generating an error polynomial based on a formula:
$$δ ← \frac{{\int }_{s}^{e} P ( x ) * Error ( x , {\hat{F}}_{crude} )}{N}$$
$$c ← s :$$
$$SP ← ∅$$
$$while c < e$$
$${δ}_{crude} ← Error ( P ( x ) , s , c , {\hat{F}}_{crude} )$$
$$if {δ}_{crude} > δ :$$
$${f}_{[ c , e ]} ( x ) ← INTERPOLATE ( [ c , e ] , F , \hat{F} , D )$$
$$SP ← S ( {f}_{[ c . e ]} ( x ) , s , c )$$
$$s ← c$$
$$c ← c + Δ$$
$$return SP$$
wherein:
F(x) is a complex activation function;
\hat{F}_{crude} is an approximation of F(x);
s is a starting point for approximation F(x);
e is an ending point for approximation F(x);
N is a number of piece-wise polynomials used for approximation;
D is a maximum degree of each of N;
i is a starting point of a domain of a plurality of domains;
j is an ending point of a domain of the plurality of domains;
ƒ_{[i,j]}(x) is a polynomial to interpolate an approximate error term between [i,j];
S(ƒ(x)i,j) is a polynomial piece S between point [i,j] with polynomial ƒ(x) of degree at most D;
P(x) is a probability distribution of x;
Δ is a step size;
δ is an approximation error;
c is a pointer starting at s, wherein c moves forward by the step size, Δ; and
SP is an approximation of the error of \hat{F}_{crude}.

15. A computer program product comprising a non-transitory computer readable medium comprising one or more instructions that, when executed by at least one processor, cause the at least one processor to:
receive data associated with a machine learning model;
generate an approximation of a complex activation function of the machine learning model;
generate an updated machine learning model based on the approximation of the complex activation function; and
provide the updated machine learning model to a plurality of multi-party computation (MPC) nodes, wherein the plurality of MPC nodes perform an inference task using the updated machine learning model as part of an MPC protocol.

16. The computer program product of claim 15, wherein the one or more instructions further cause the at least one processor to:
provide a result of the inference task using the MPC protocol.

17. The computer program product of claim 15, wherein, the one or more instructions that cause the at least one processor to generate the approximation of the complex activation function of the machine learning model, cause the at least one processor to:
determine a first output of the machine learning model using a first activation function;
calculate an approximate error term using an error polynomial based on the first output of the machine learning model, wherein the error polynomial comprises a plurality of spline-based terms; and
generate an approximation of an output of the machine learning model using a second activation function based on the first output of the machine learning model and the approximate error term; and
wherein the first activation function comprises the complex activation function and the second activation function comprises the approximation of a complex activation function of the machine learning model.

18. The computer program product of claim 17, wherein the plurality of spline-based terms comprises a plurality of unevenly spaced 1 dimensional splines.

19. The computer program product of claim 15, wherein, the one or more instructions that cause the at least one processor to calculate an approximate error term, cause the at least one processor to:
sum a plurality of spline-based terms.

20. The computer program product of claim 15, wherein the one or more instructions further cause the at least one processor to:
cause the inference task to be performed by the plurality of MPC nodes using the updated machine learning model as part of the MPC protocol.

21. The computer program product of claim 15, wherein the one or more instructions further cause the at least one processor to:
generate an error polynomial based on a formula:
$$δ ← \frac{{\int }_{s}^{e} P ( x ) * Error ( x , {\hat{F}}_{crude} )}{N}$$
$$c ← s :$$
$$SP ← ∅$$
$$while c < e$$
$${δ}_{crude} ← Error ( P ( x ) , s , c , {\hat{F}}_{crude} )$$
$$if {δ}_{crude} > δ :$$
$${f}_{[ c , e ]} ( x ) ← INTERPOLATE ( [ c , e ] , F , \hat{F} , D )$$
$$SP ← S ( {f}_{[ c . e ]} ( x ) , s , c )$$
$$s ← c$$
$$c ← c + Δ$$
$$return SP$$
wherein:
F(x) is a complex activation function;
\hat{F}_{crude} is an approximation of F(x);
s is a starting point for approximation F(x);
e is an ending point for approximation F(x);
N is a number of piece-wise polynomials used for approximation;
D is a maximum degree of each of N;
i is a starting point of a domain of a plurality of domains;
j is an ending point of a domain of the plurality of domains;
ƒ_{[i,j]}(x) is a polynomial to interpolate an approximate error term between [i,j];
S(ƒ(x)i,j) is a polynomial piece S between point [i,j] with polynomial ƒ(x) of degree at most D;
P(x) is a probability distribution of x;
Δ is a step size;
δ is an approximation error;
c is a pointer starting at s, wherein c moves forward by the step size, Δ; and
SP is an approximation of the error of \hat{F}_{crude}.
